(19) United States
(12) Patent Application Publication
(10) Pub. No.: US 2015/0186451 A1
(43) Pub. Date: Jul. 2, 2015

(54) CONTROLLER, AND ACCESS CONTROL METHOD

(71) Applicant: FUJITSU LIMITED, Kawasaki-shi (JP)

(72) Inventors: Hiroyoshi Okada, Ibaraki (JP); Koichi Tomitaka, Kobe (JP); Yutaka Arakawa, Kobe (JP); Hisashi Sawada, Kobe (JP)

(21) Appl. No.: 14/561,688

(22) Filed: Dec. 5, 2014

(30) Foreign Application Priority Data
Dec. 27, 2013 (JP) 2013-273571

(51) Int. Cl. G06F 17/30; G06F 9/50; G06F 9/46

(52) U.S. Cl. CPC G06F 17/30377; G06F 9/467; G06F 9/5077

(57) ABSTRACT

A controller accumulates, for each of a plurality of applications executed by batch processing, exclusive information of an area corresponding to an access position and a size of an access area when the application accesses a storage area of a processing target file. The controller executes exclusive control for an area that is specified by the exclusive information of the area in the storage area when any of the applications accesses the storage area on the basis of the exclusive information of the area accumulated by the accumulation processing.

### CROSS-REFERENCE TO RELATED APPLICATION(S)

This application is based upon and claims the benefit of priority of the prior Japanese Patent Application No. 2013-273571, filed on Dec. 27, 2013, the entire contents of which are incorporated herein by reference.

### FIELD

The embodiment discussed herein is related to an access control program and the like.

### BACKGROUND

Conventionally, a general file that differs from a table used in a database has been used in transfer of data from an application in batch processing. The general file is, for example, a text file. In exclusive control to a general file, when access from an application to the file occurs, access to the file from another application is suppressed. Accordingly, the exclusive control maintains data integrity.
Patent Literature 1: Japanese Laid-open Patent Publication No. 03-268146

However, disadvantageously, it is difficult to execute efficiently parallel processing in a plurality of applications in conventional batch processing. Specifically, even when a plurality of applications access different data areas in a single file, the file is excluded in batch processing because the applications access the same file. Therefore, it is difficult to execute efficiently parallel processing in the applications.

### SUMMARY

According to an aspect of an embodiment, a non-transitory computer-readable recording medium stores therein an access control program that causes a computer to execute a process. The process includes accumulating, for each of a plurality of applications executed by batch processing, an area information indicating information of an access position and a size of an access area when the application accesses a storage area of a storage unit. The process includes executing, when any of the applications accesses the storage area, exclusive control for an area that is specified by the area information and that corresponds to the any of the applications on the basis of the area information accumulated at the accumulating.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a functional configuration of a controller according to an embodiment;

FIG. 2 is a diagram explaining an example of data contention occurring between applications;

FIG. 3 is a diagram illustrating a developed image of information used in access control processing according to the embodiment;

FIG. 4 is a diagram explaining an outline of the access control processing according to the embodiment;

FIG. 5A is a diagram illustrating the data structure of statistical information;

FIG. 5B is a diagram illustrating the data structure of a statistical information entry in the statistical information;

FIG. 5C is a diagram illustrating a specific example of the statistical information entry;

FIG. 6A is a diagram illustrating the data structure of resource information in exclusive information;

FIG. 6B is a diagram illustrating the data structure of a resource information entry in the resource information;

FIG. 6C is a diagram illustrating the data structure of block information in the resource information entry;

FIG. 7A is a diagram illustrating the data structure of transaction information in the exclusive information;

FIG. 7B is a diagram illustrating the data structure of a transaction entry in the transaction information;

FIG. 8 is a diagram illustrating the data structure of access information in the exclusive information;

FIG. 9 is a diagram illustrating the data structure of an exclusive queue in the exclusive information;

FIG. 10 is a diagram explaining an exclusive target block;

FIG. 11 is a diagram explaining exclusive control of the access control processing according to the embodiment;

FIG. 12 is a flowchart illustrating the procedure of open processing according to the embodiment;

FIG. 13 is a flowchart illustrating the procedure of read processing according to the embodiment;

FIG. 14A is a flowchart (1) illustrating the procedure of write processing according to the embodiment;

FIG. 14B is a flowchart (2) illustrating the procedure of the write processing according to the embodiment;

FIG. 15 is a flowchart illustrating the procedure of seek processing according to the embodiment;

FIG. 16 is a flowchart illustrating the procedure of close processing according to the embodiment;

FIG. 17 is a diagram explaining a specific example of the access control processing according to the embodiment;

FIG. 18 is a diagram illustrating a specific configuration example of the controller according to the embodiment; and

FIG. 19 is a diagram illustrating an example of a computer that executes an access control program.

### DESCRIPTION OF EMBODIMENT

Preferred embodiments of the present invention will be explained with reference to accompanying drawings. However, the present invention is not limited to the embodiment.

### Configuration of Controller According to Embodiment

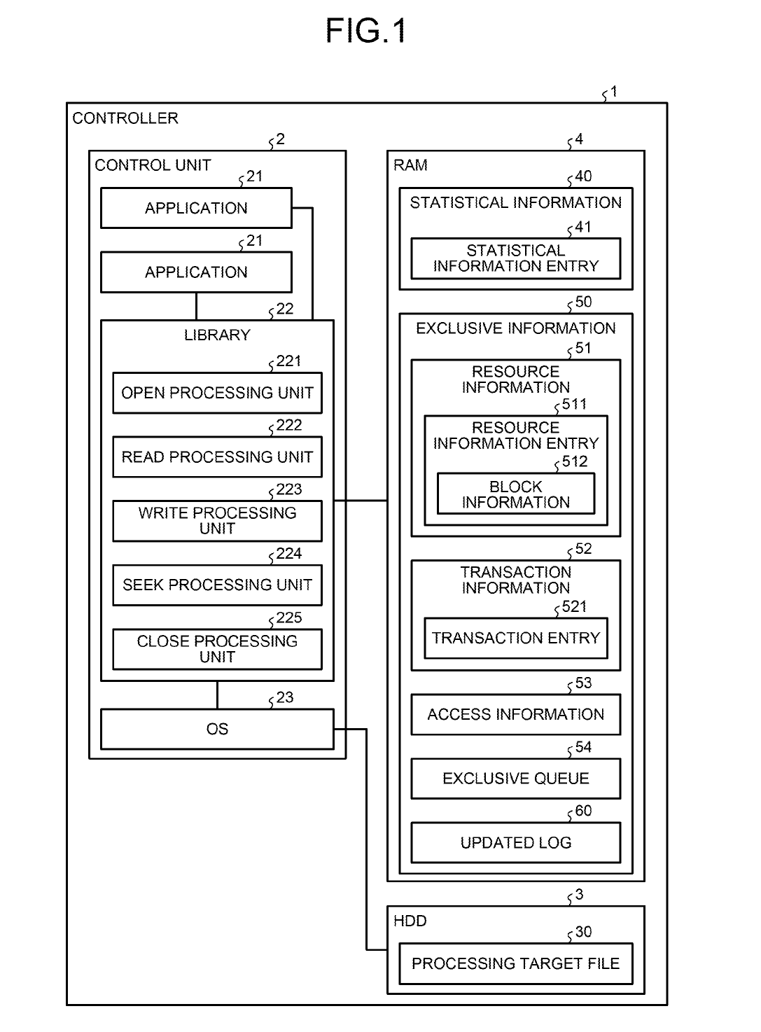

FIG. 1 is a block diagram illustrating the configuration of the controller according to the embodiment. As illustrated in FIG. 1, a controller 1 includes a control unit 2, an HDD (Hard Disk Drive) 3, and a RAM (Random Access Memory) 4.

The control unit 2 includes a program that defines various processing procedures and an internal memory for storing control data, and executes various kinds of processing using the program and the internal memory. The control unit 2, for example, corresponds to an integrated electronic circuit such as an ASIC (Application Specific Integrated Circuit) and a FPGA (Field Programmable Gate Array). Alternatively, the control unit 2 corresponds to an electronic circuit such as a CPU (Central Processing Unit) and an MPU (Micro Processing Unit). Further, the control unit 2 includes an application 21, a library 22, and an OS (Operating System) 23.

The application 21 is a program executed by batch processing. The library 22 includes a plurality of modules called from the application 21. The modules include, for example, open processing, read processing, write processing, seek processing, and close processing all regarding a file. The open processing corresponds to an open processing unit 221 (described below). The read processing corresponds to a read processing unit 222 (described below). The write processing corresponds to a write processing unit 223 (described below). The seek processing corresponds to a seek processing unit 224 (described below). The close processing corresponds to a close processing unit 225 (described below). The OS 23 includes a module regarding an input/output control function for a file called from each of the modules of the library 22.

A processing target file 30 is stored in the HDD 3. The processing target file 30 is a target to be read and written by the application 21. The processing target file 30 is a general file that differs from a table used in a database (DB), for example, a text file. The processing target file 30 is an example of an access area.

Here, a problem caused in batch processing of reading/writing data from/into the processing target file 30 will be described. A plurality of applications 21 executed by batch processing read and write data from and into the same processing target file 30. In this case, the plurality of applications 21 may write data into the same area of the same processing target file 30. That is, data contention may occur between the applications 21.

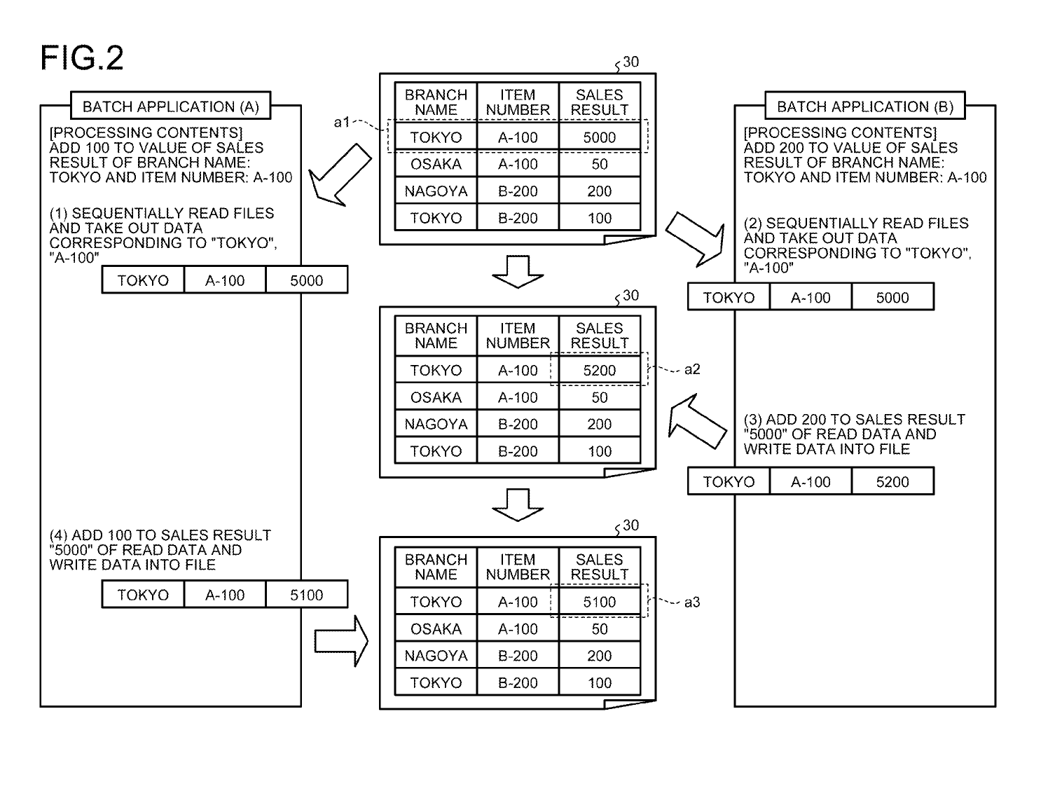

FIG. 2 is a diagram explaining an example of data contention occurring between applications. Two applications 21 executed by batch processing will be described as a batch application A and a batch application B. As illustrated in FIG. 2, the batch application A and the batch application B are processed in parallel. A processing target of each of the batch applications A and B is the same processing target file 30. In the processing target file 30, an item number and a sales result are stored in association with each branch name. The batch application A has processing contents of adding 100 to a value of a sales result that is associated with the branch name “TOKYO” and the item number “A-100”. On the other hand, the batch application B has processing contents of adding 200 to a value of the sales result that is associated with the branch name “TOKYO” and the item number “A-100”.

Under such conditions, the batch application A sequentially reads data from the processing target file 30 to thereby read data corresponding to the branch name “TOKYO” and the item number “A-100”. In this example, the batch application A reads data (a1) corresponding to the branch name “TOKYO”, the item number “A-100”, and the sales result “5000”.

Then, the batch application B sequentially reads data from the processing target file 30 to thereby take out data that matches the branch name “TOKYO” and the item number “A-100”. In this example, the batch application B reads the data (a1) corresponding to the branch name “TOKYO”, the item number “A-100”, and the sales result “5000”. Then, the batch application B adds “200” to a value “5000” of the sales result of the read data and writes data containing the added value “5200” of the sales result into the processing target file 30. In this example, a value of the sales result associated with the branch name “TOKYO” and the item number “A-100” in the processing target file 30 is stored as “5200” (a2).

Then, the batch application A adds “100” to the value “5000” of the sales result of the read data and writes data containing the added value “5100” of the sales result into the processing target file 30. In this example, the value of the sales result associated with the branch name “TOKYO” and the item number “A-100” in the processing target file 30 is stored as “5100” (a3). That is, the value “5200” of the sales result written by the batch application B is updated by the value “5100” of the sales result written by the batch application A. In other words, contention occurs between the batch application A and the batch application B.

Therefore, in order to maintain data integrity when data contention occurs between applications 21, the controller 1 determines processing in which the contention occurs as an error. That is, the controller 1 accumulates, for each of a plurality of applications 21 executed by batch processing, information of an area corresponding to an access position and an access size when the application 21 actually accesses the processing target file 30. Then, when any of the applications 21 actually accesses the processing target file 30, the controller 1 executes exclusive control for the accessed area on the basis of the accumulated area information. A unit for executing the exclusive control is a prescribed fixed block length. The block length may be a previously determined length or may be a length that is statistically calculated from the size of data having a value updated in the past. The controller 1 having such a configuration will be described in detail below.

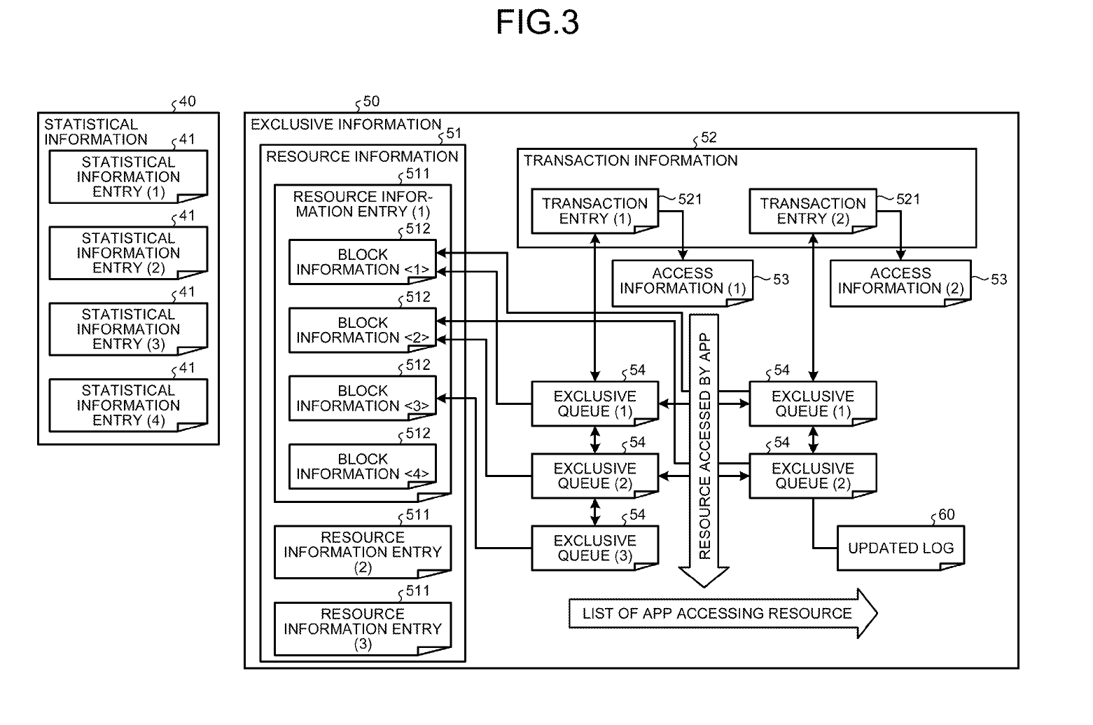

Referring back to FIG. 1, statistical information 40, exclusive information 50, and an updated log 60 are developed in the RAM 4. Here, developed images of the statistical information 40, the exclusive information 50, and the updated log 60 will be described with reference to FIG. 3. FIG. 3 is a diagram illustrating a developed image of information used in access control processing according to the embodiment.

The statistical information 40 is used for defining the block length of a file. The statistical information 40 includes a statistical information entry 41 such as “an actually updated size” obtained when the application 21 updates the processing target file 30. As illustrated in FIG. 3, the statistical information entry 41 is generated for each application 21 and each processing target file 30. A detailed data structure of the statistical information 40 will be described below.

The exclusive information 50 is used for performing exclusive control by each of the processing units in the library 22. The exclusive information 50 includes resource information 51, transaction information 52, access information 53, and an exclusive queue 54.

The resource information 51 includes, for each processing target file 30 as a resource, a resource information entry 511 such as the number of open applications 21, a current block length, and block information 512 of a block being in use. In the block information 512 of the resource information entry 511, for each block in the processing target file 30 as a resource, transition of access to the block is represented and the top and last addresses of the exclusive queue 54 (described below) are stored. As illustrated in FIG. 3, the block information 512 is generated for each block.

The transaction information 52 includes a transaction entry 521. In the transaction entry 521, for each application 21, transition of access of the application 21 to a block in the processing target file 30 as a resource is represented and the top and last addresses of the exclusive queue 54 (described below) are stored. As illustrated in FIG. 3, the transaction entry 521 is generated for each application 21.

The access information 53 is used when the application 21 accesses the file. As illustrated in FIG. 3, the access information 53 is generated for each application 21. In each exclusive queue 54, there are stored an exclusive mode when the block is accessed, addresses of other exclusive queues 54 acquired before and after the present exclusive queue 54 in a processing direction of the application 21, and addresses of other exclusive queues 54 acquired before and after the present exclusive queue 54 in an access direction of the block. The exclusive mode includes an occupancy mode (EX) which indicates that a block is occupied and a share mode (SH) which indicates that a block is not occupied. As an example, the occupancy mode is stored when a block is an update target and the share mode is stored when a block is a reference target. As illustrated in FIG. 3, the exclusive queue 54 is generated every time when the application 21 accesses the block. A detailed data structure of the exclusive information 50 will be described below.

In the updated log 60, data to be actually updated is stored in the unit of block. The data stored in the updated log 60 are collectively written into the processing target file 30 when access to the processing target file 30 finishes. This is because of that, after confirming that update processing is not performed for the same block with respect to all applications 21 that access the processing target file 30 in parallel, the data are written into the block. As illustrated in FIG. 3, when an exclusive queue 54 corresponds to an update target block, an address of the updated log 60 that stores data to be updated is stored in the exclusive queue 54.

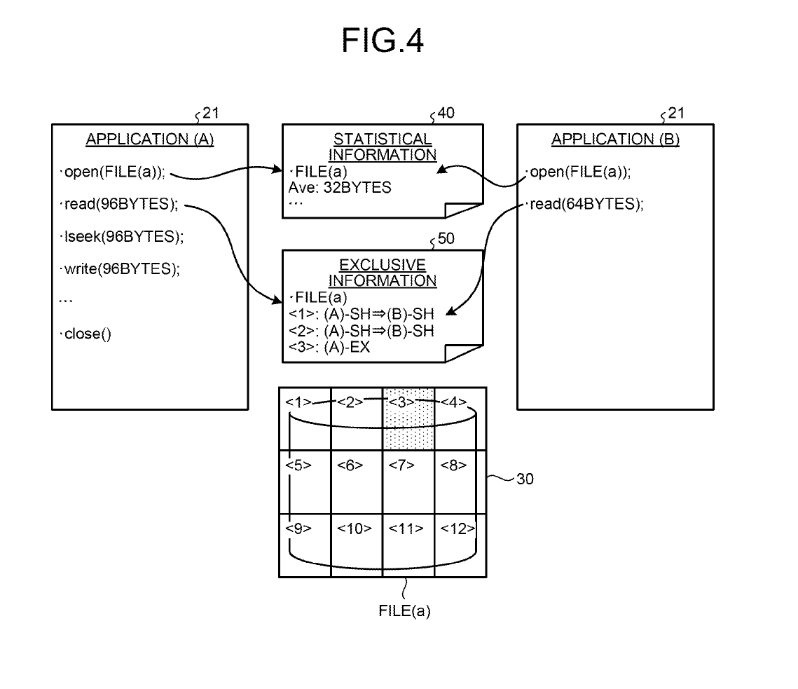

The controller 1 executes access control processing for the processing target file 30 that is accessed from the applications 21 executed by batch processing using the statistical information 40 and the exclusive information 50. FIG. 4 is a diagram explaining an outline of the access control processing according to the embodiment. Two applications 21 executed by batch processing will be described as an application A and an application B. As illustrated in FIG. 4, the application A and the application B are processed in parallel. The application A and the application B both use a file a as the same processing target file 30.

The access control processing divides the file a into block units on the basis of “the size of the actually updated data” stored in the statistical information 40 at the time of open in the processing by the applications 21. In this example, when “the size of the actually updated data” stored in the statistical information 40 is 32 bytes, the access control processing divides the file a by setting the block length to 32 bytes.

Then, the access control processing accumulates information of an area corresponding to an access position and an access size when the application A accesses the file a. For example, when a read request of 96 bytes is issued to the file a from the application A, the access control processing accumulates access information of an area that is actually read and a block as the read area in the exclusive information 50. In this example, the access control processing connects exclusive queues 54 corresponding to blocks 1, 2, 3 in the processing direction of the application A. The share mode “SH” is stored in the exclusive queues 54 as the exclusive mode. Then, when a write request of 96 bytes is issued to the file a from the application A, the access control processing accumulates access information of a block that is a write target area in the exclusive information 50. In this example, when only a part of the write request data, the part corresponding to the block 3, is actually updated, the access control processing connects the exclusive queue 54 corresponding to the block 3 in the processing direction of the application A. The occupancy mode “EX” is stored in the exclusive queue 54 as the exclusive mode. The actually updated part is written into the updated log 60 in the unit of block.

Then, the access control processing accumulates information of an area corresponding to an access position and an access size when the application B accesses the file a. For example, when a read request of 64 bytes is issued to the file a from the application B, the access control processing accumulates access information of an area that is actually read and a block as the read area in the exclusive information 50. In this example, the access control processing connects exclusive queues 54 corresponding to the blocks 1, 2 in the processing direction of the application B. The share mode “SH” is stored in the exclusive queues 54 as the exclusive mode. Further, the access control processing connects exclusive queues 54 in the same block in the access direction of the block. In this example, the access control processing connects an exclusive queue 54 of the application B so as to follow an exclusive queue 54 of the application A, the exclusive queues 54 corresponding to the block 1.

Then, the access control processing executes exclusive control for a block that includes the actually updated part on the basis of the exclusive information 50. In this example, the access control processing executes the exclusive control for the block 3 that includes the actually updated part. If, in the subsequent processing, the application B has a write request of data corresponding to the block 3, the block 3 is defined as an exclusive target and the processing to the block 3 is determined as an error.

Referring back to FIG. 1, the library 22 includes the open processing unit 221, the read processing unit 222, the write processing unit 223, the seek processing unit 224, and the close processing unit 225. Each of the processing units of the library 22 is called by the application 21. Further, the read processing unit 222 and the write processing unit 223 are examples of an accumulation unit. The write processing unit 223 is an example of an execution unit.

The open processing unit 221 opens the processing target file 30 that is specified by the application 21.

For example, the open processing unit 221 decides whether a file name of the specified processing target file 30 exists in the resource information 51. Then, when deciding that the file name of the processing target file 30 does not exist in the resource information 51, the open processing unit 221 registers a new resource information entry 511 that corresponds to the processing target file 30 in the resource information 51. In addition, the open processing unit 221 sets default to a statistical information entry 41 that corresponds to the application 21 and the processing target file 30. On the other hand, when the open processing unit 221 decides that the file name of the processing target file 30 exists in the resource information 51 and another application 21 is opening the processing target file 30, a block length that is equal to the block length of the application 21 that is opening the processing target file 30 is defined as a block length to be used. When another application 21 is not opening the processing target file 30, a block length that corresponds to the processing target file 30 of the statistical information 40 is taken out, and the taken-out block length is defined as a block length to be used. Then, the open processing unit 221 acquires a transaction entry 521 that corresponds to the application 21 and opens the processing target file 30.

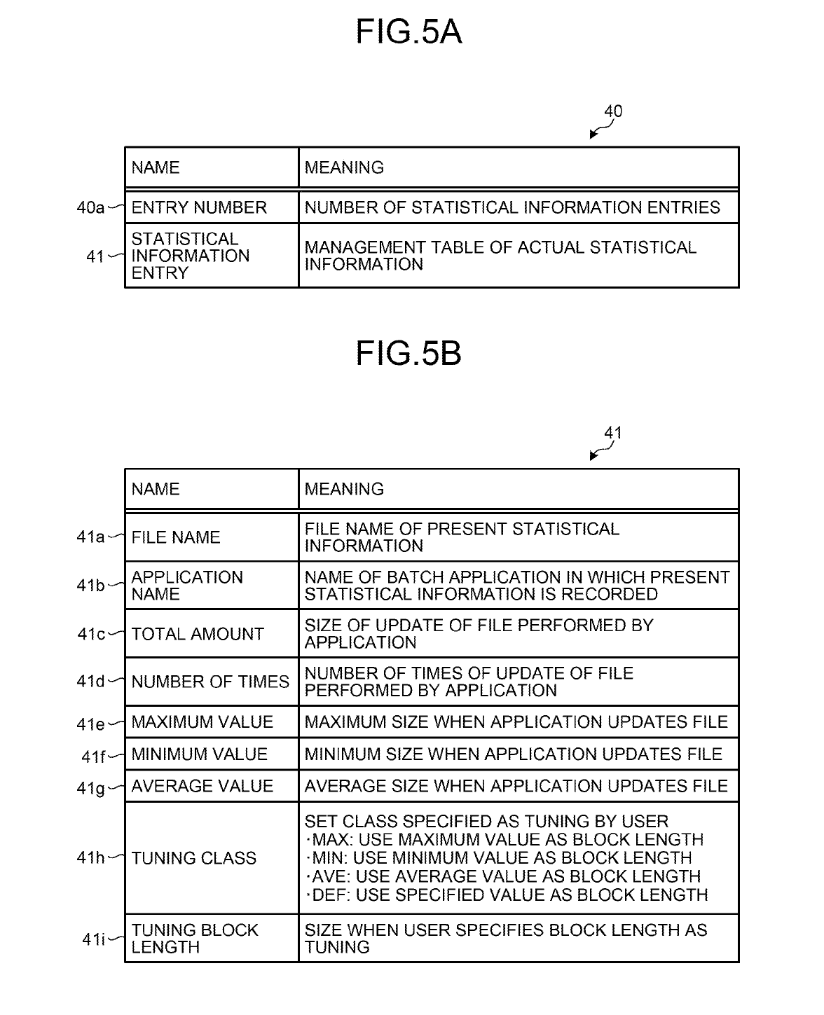

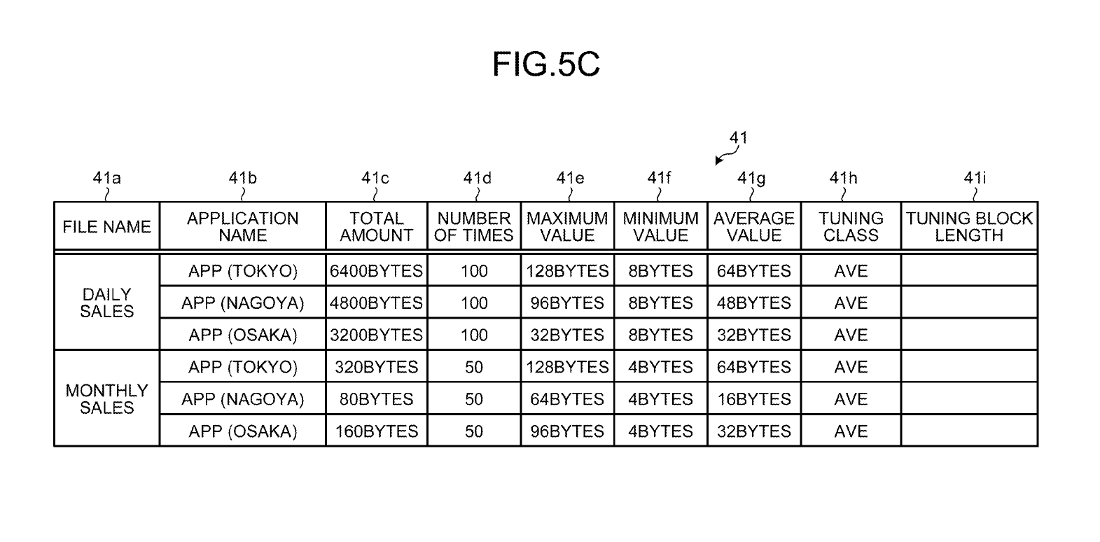

Here, an example of the data structure of the statistical information will be described with reference to FIGS. 5A to 5C. FIG. 5A is a diagram illustrating the data structure of the statistical information. FIG. 5B is a diagram illustrating the data structure of the statistical information entry in the statistical information. FIG. 5C is a diagram illustrating a specific example of the statistical information entry.

As illustrated in FIG. 5A, the statistical information 40 stores an entry number 40a and a statistical information entry 41. The entry number 40a represents the number of statistical information entries 41. The statistical information entry 41 represents a management table of actual statistical information. The statistical information entry 41 exists for each file name and each application name of the processing target file 30.

As illustrated in FIG. 5B, the statistical information entry 41 stores a total amount 41c, a number of times 41d, a maximum value 41e, a minimum value 41f, an average value 41g, a tuning class 41h, and a tuning block length 41i in association with a file name 41a and an application name 41b. The file name 41a represents a file name of the processing target file 30. That is, the file name 41a is a file name of the processing target file 30 that is accessed from the application 21 that executes batch processing. The application name 41b is a file name of the application 21 that executes batch processing.

The total amount 41c represents the total size of update of the processing target file 30 represented by the file name 41a performed by the application 21 represented by the application name 41b in the past. The number of times 41d represents the number of times of updating the processing target file 30 represented by the file name 41a by the application 21 represented by the application name 41b in the past. The maximum value 41e represents the maximum size of update of the processing target file 30 represented by the file name 41a performed by the application 21 represented by the application name 41b in the past. The minimum value 41f represents the minimum size of update of the processing target file 30 represented by the file name 41a performed by the application 21 represented by the application name 41b in the past. The average value 41g represents an average size of update of the processing target file 30 represented by the file name 41a performed by the application 21 represented by the application name 41b in the past. That is, the maximum value 41e, the minimum value 41f, and the average value 41g each correspond to “the size of the actually updated data”.

The tuning class 41h represents a tuning class of the block length. That is, the tuning class 41h is a tuning class that is used when the open processing unit 221 determines the block length. As the tuning class 41h, for example, “MAX” is set when the block length is the maximum value 41e, “MIN” is set when the block length is the minimum value 41f, and “AVE” is set when the block length is the average value 41g. As the tuning class 41h, “DEF” is set when the block length is a tuning block length 41i (described below). When the tuning class 41h is omitted, for example, “AVE” is set. The tuning block length 41i represents a previously set block length. The tuning class 41h and the tuning block length 41i are specified, for example, by a user.

As illustrated in FIG. 5C, as an example, when the file name 41a is “daily sales”, “APP (TOKYO)” as the application name 41b, “6400 byte” as the total amount 41c, and “100” as the number of times 41d are stored. Further, “128 byte” as the maximum value 41e, “8 byte” as the minimum value 41f, “64 byte” as the average value 41g, “AVE” as the tuning class 41h, and “ ” as the tuning block length 41i are stored.

Referring back to FIG. 1, the read processing unit 222 reads data of the corresponding block on the basis of an access position and an access size of the processing target file 30 specified by the application 21. For example, the read processing unit 222 calculates blocks to be access targets on the basis of the access position and the access size of the processing target file 30 specified by the application 21. Then, the read processing unit 222 connects exclusive queues 54 in the share mode (SH) of the respective calculated blocks in the exclusive information 50. Specifically, the read processing unit 222 connects the exclusive queues 54 that correspond to the calculated blocks in a direction connected from the transaction entry 521 corresponding to the application 21, that is, in the processing direction of the application 21. Further, the read processing unit 222 connects the exclusive queues 54 that correspond to the calculated blocks in a direction connected from the block information 512 in the resource information 51, that is, in the access direction of the blocks. Then, the read processing unit 222 reads data of each of the calculated blocks and updates the access position.

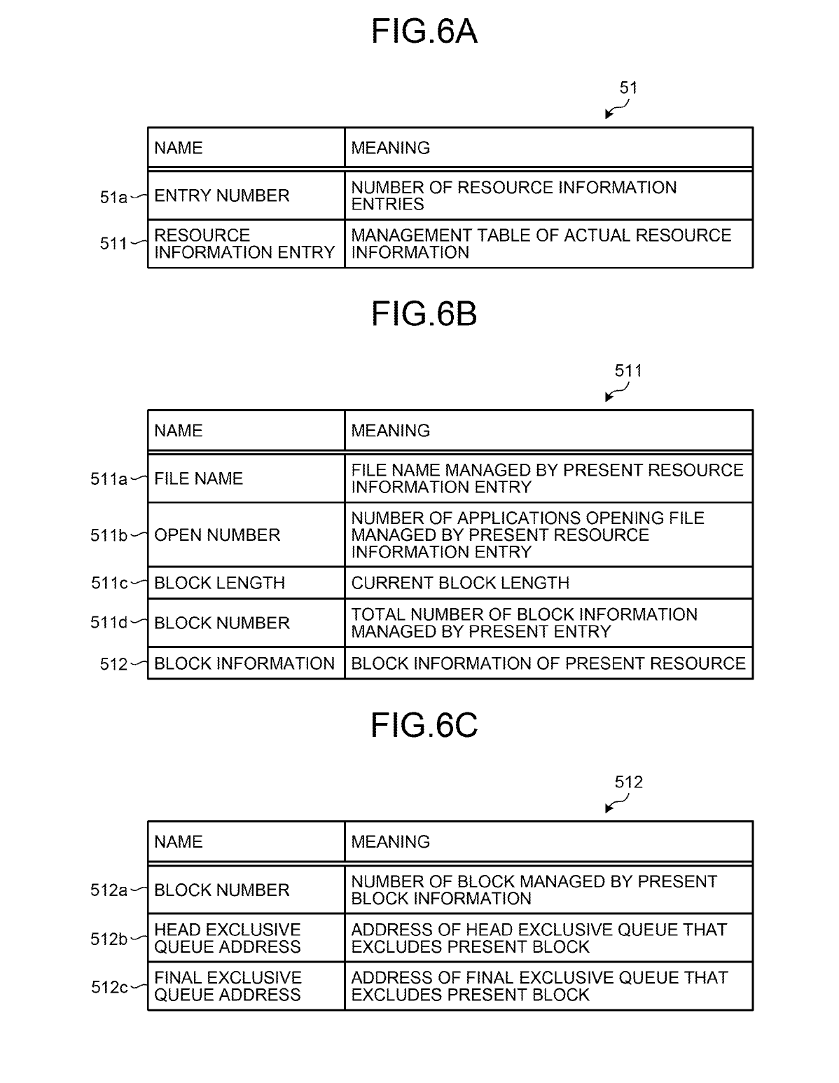

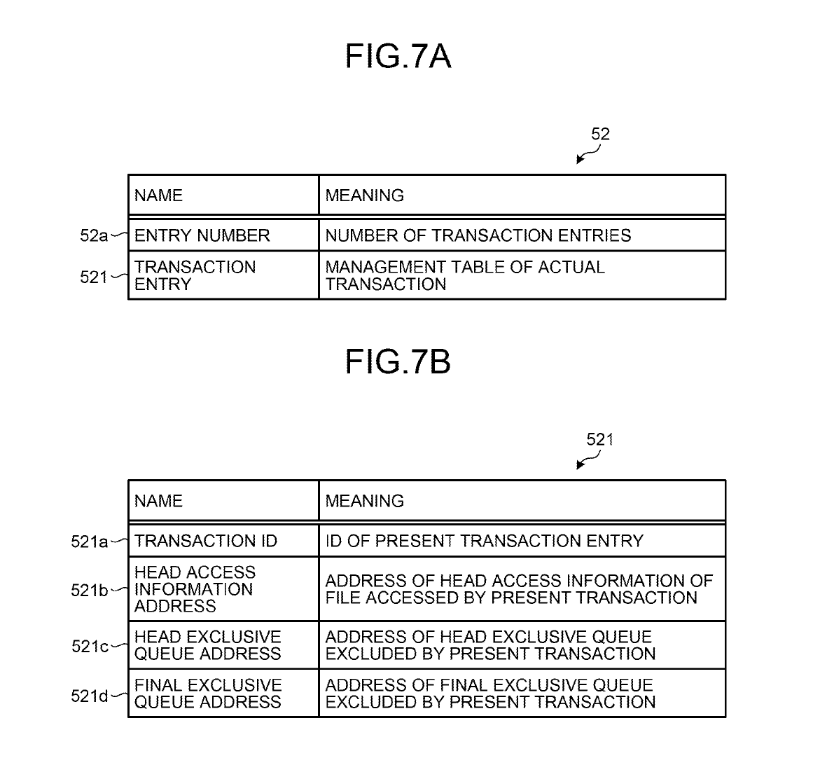

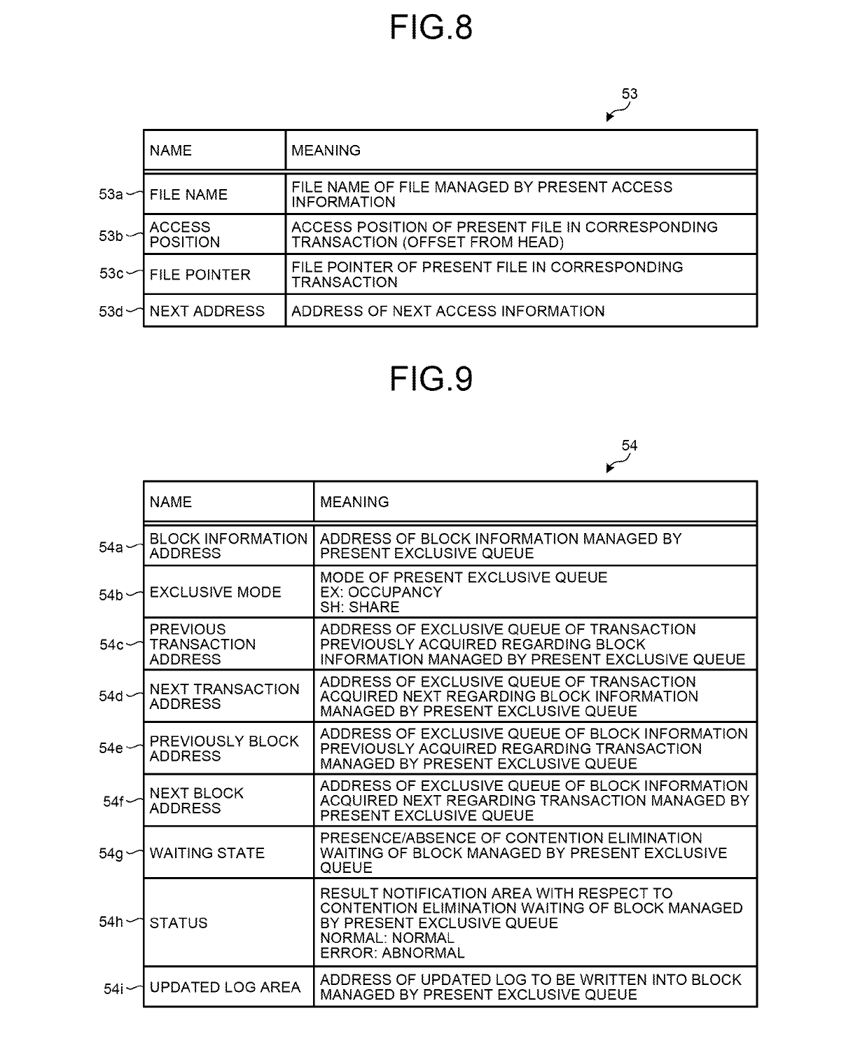

Here, an example of the data structure of the exclusive information 50 will be described with reference to FIGS. 6A to 9. FIGS. 6A to 6C each illustrate the data structure of resource information in the exclusive information. FIGS. 7A and 7B each illustrate the data structure of transaction information in the exclusive information. FIG. 8 illustrates the data structure of access information in the exclusive information. FIG. 9 illustrates the data structure of an exclusive queue in the exclusive information.

FIG. 6A is a diagram illustrating the data structure of resource information in the exclusive information. As illustrated in FIG. 6A, the resource information 51 stores an entry number 51a and a resource information entry 511. The entry number 51a represents the number of resource information entries 511. The resource information entry 511 represents a management table of actual resource information. The resource information entry 511 exists for each file name of the processing target file 30.

FIG. 6B is a diagram illustrating the data structure of a resource information entry in the resource information. As illustrated in FIG. 6B, the resource information entry 511 stores an open number 511b, a block length 511c, a block number 511d, and block information 512 in association with a file name 511a. The file name 511a represents a file name of the processing target file 30 that is managed by the present resource information entry 511. The open number 511b represents the number of applications 21 that open the processing target file 30 represented by the file name 511a. The block length 511c represents a current block length. In the block length 511c, a block length that is taken out from the statistical information 40 by the open processing unit 221 is stored at the time of open. The block number 511d represents the total number of pieces of the block information 512. The block information 512 is information about a block that is a resource of the processing target file 30 represented by the file name 511a. The block information 512 exists for each block.

FIG. 6C is a diagram illustrating the data structure of block information in the resource information entry. As illustrated in FIG. 6C, the block information 512 stores a block number 512a, a head exclusive queue address 512b, and a final exclusive queue address 512c in association with each other. The block number 512a represents a number of a block that is managed by the present block information 512. The head exclusive queue address 512b represents an address of the head one of exclusive queues regarding the block represented by the block number 512a. The final exclusive queue address 512c indicates an address of the final one of the exclusive queues regarding the block represented by the block number 512a. That is, the block information 512 manages the access direction with respect to the block represented by the block number 512a.

FIG. 7A is a diagram illustrating the data structure of transaction information in the exclusive information. As illustrated in FIG. 7A, the transaction information 52 stores an entry number 52a and a transaction entry 521. The entry number 52a represents the number of transaction entries 521. The transaction entry 521 represents a management table of an actual transaction. The transaction entry 521 exists for each application 21.

FIG. 7B is a diagram illustrating the data structure of a transaction entry in the transaction information. As illustrated in FIG. 7B, the transaction entry 521 stores a transaction ID (identification) 521a, a head access information address 521b, a head exclusive queue address 521c, and a final exclusive queue address 521d in association with each other. The transaction ID 521a represents an ID of a transaction managed by the present transaction entry 521. The head access information address 521b represents an address of the head one of access information 53 of a file that is accessed by the transaction managed by the present transaction entry 521. The head exclusive queue address 521c represents an address of the head one of exclusive queues regarding the transaction represented by the transaction ID 521a. The final exclusive queue address 521d represents an address of the final one of the exclusive queues regarding the transaction represented by the transaction ID 521a. That is, the transaction entry 521 manages the processing direction of the application 21 that is processed by the transaction represented by the transaction ID 521a.

FIG. 8 is a diagram illustrating the data structure of access information in the exclusive information. As illustrated in FIG. 8, the access information 53 stores a file name 53a, an access position 53b, a file pointer 53c, and a next address 53d in association with each other. The file name 53a represents a file name of the processing target file 30 managed by the present access information. That is, the file name 53a is a file name of the processing target file 30 that is accessed by the transaction represented by the transaction ID 521a. The access position 53b represents the latest access position of the processing target file 30 represented by the file name 53a. That is, the access position 53b is represented by offset from the head of the file. The file pointer 53c represents a file pointer of the file represented by the file name 53a. The next address 53d represents an address of the next access information. That is, the next address information is set to the next address 53d when a different file is further accessed in the same transaction.

FIG. 9 is a diagram illustrating the data structure of an exclusive queue in the exclusive information. As illustrated in FIG. 9, the exclusive queue 54 stores an exclusive mode 54b, a previous transaction address 54c, a next transaction address 54d, a previous block address 54e, and a next block address 54f in association with a block information address 54a. Further, the exclusive queue 54 stores a waiting state 54g, a status 54h, and an updated log area 54i in association with the block information address 54a.

The exclusive queue 54 is generated at each access to a block of the processing target file 30. The block information address 54a represents an address of the block information 512 managed by the present exclusive queue 54. The exclusive mode 54b represents an exclusive mode of the present exclusive queue 54. As an example, “EX” is set as an occupancy mode indicating that the block is occupied and “SH” is set as a share mode indicating that the block is not occupied.

The previous transaction address 54c relates to the block information 512 managed by the present exclusive queue 54 and represents an address of an exclusive queue of another transaction that is previously acquired. For example, when the present transaction is the head one, NULL is set to the previous transaction address 54c. On the other hand, an address of an exclusive queue of another transaction that is acquired prior to the present transaction is set when the present transaction is not the head one. The next transaction address 54d relates to the block information 512 managed by the present exclusive queue 54 and represents an address of an exclusive queue of a transaction that is acquired next to the present transaction. For example, when the present transaction is the last one, NULL is set to the next transaction address 54d. On the other hand, the present transaction is not the last one, an address of an exclusive queue of another transaction that is acquired next to the present transaction is set to the next transaction address 54d. That is, the library 22 can follow the transition of access to the block represented by the block number 512a in the block information 512 by using the previous transaction address 54c, the next transaction address 54d, and the block information 512.

The previous block address 54e relates to a transaction managed by the present exclusive queue 54 and represents an address of an exclusive queue of the previously acquired block information 512. For example, when the present block is the head one, NULL is set to the previous block address 54e. On the other hand, when the present transaction is not the head one, an address of an exclusive queue of a block that is acquired prior to the present block in the present transaction is set to the previous block address 54e. The next block address 54f relates to the transaction managed by the present exclusive queue 54 and represents an address of an exclusive queue of the block information 512 that is acquired next to the present block. For example, when the present block is the last one, NULL is set to the next block address 54f. On the other hand, when the present block is not the last one, an address of an exclusive queue of a block that is acquired next to the present block in the present transaction is set to the next block address 54f. That is, the library 22 can follow the transition of the processing of the application 21 processed by the transaction of the transaction entry 521 by using the previous block address 54e, the next block address 54f, and the transaction entry 521.

The waiting state 54g represents the presence or absence of contention elimination waiting of the block managed by the present exclusive queue 54. For example, when there is no contention elimination waiting state, NULL is set to the waiting state 54g. On the other hand, when there is a contention elimination waiting state, other than NULL is set to the waiting state 54g. The status 54h represents a result notification area with respect to the contention elimination waiting of the block managed by the present exclusive queue 54. For example, when the state is normal, “NORMAL” which represents normality is set to the status 54h. On the other hand, when the state is abnormal, “ERROR” which represents abnormality is set to the status 54h. The updated log area 54i represents an address of the updated log 60 that indicates data to be written into the block managed by the present exclusive queue 54. For example, when update processing is performed on the block managed by the present exclusive queue 54, the write processing unit 223 (described below) sets an address of the updated log 60 that stores data written into the processing target file 30 at the time of commitment of the transaction.

Referring back to FIG. 1, the write processing unit 223 performs write processing of data to the corresponding block on the basis of the access position and the access size of the processing target file 30 specified by the application 21. For example, the write processing unit 223 calculates write target blocks from the write size. Then, the write processing unit 223 reads data of all of the calculated blocks and compares the read data with data that is requested to be written to thereby decide the presence or absence of change for each of the blocks.

The write processing unit 223 determines blocks having no change as reference targets, and connects exclusive queues 54 in the share mode (SH) of the respective calculated blocks in the exclusive information 50. As an example, the write processing unit 223 connects the exclusive queues 54 that correspond to the corresponding blocks in the direction connected from the transaction entry 521 corresponding to the application 21, that is, the processing direction of the application 21. Further, the read processing unit 222 connects the exclusive queues 54 that correspond to the corresponding blocks in the direction connected from the block information 512 in the resource information 51, that is, the access direction of the blocks.

The write processing unit 223 determines blocks having a change as update targets, that is, exclusive targets, and connects exclusive queues 54 in the occupancy mode (EX) of the respective calculated blocks in the exclusive information 50. As an example, the write processing unit 223 connects the exclusive queues 54 that correspond to the corresponding blocks in the direction connected from the transaction entry 521 corresponding to the application 21, that is, the processing direction of the application 21. Further, the read processing unit 222 connects the exclusive queues 54 that correspond to the corresponding blocks in the direction connected from the block information 512 in the resource information 51, that is, the access direction of the blocks. Then, the write processing unit 223 temporarily writes updated data corresponding to the blocks having a change into the updated log 60.

Then, the write processing unit 223 decides whether another exclusive queue 54 in the occupancy mode (EX) exists regarding the exclusive target block with reference to the exclusive information 50. As an example, the write processing unit 223 follows the exclusive queues 54 from the block information 512 that corresponds to the exclusive target block in the resource information 51 to thereby decide whether an exclusive queue 54 in the occupancy mode (EX) exists in the other exclusive queues 54. Then, when another exclusive queue 54 in the occupancy mode (EX) exists, the write processing unit 223 determines an exclusive error. As a result, even when a plurality of applications 21 operate in parallel, the applications 21 can access the same access target, that is, the same processing target file 30, without affecting each other.

Then, when another exclusive queue 54 in the occupancy mode (EX) exists and the exclusive queue 54 is in a waiting state, the write processing unit 223 sets abnormality to the exclusive queue 54 in order to notify an exclusive error. As an example, when the waiting state 54g of the exclusive queue 54 is other than NULL, the write processing unit 223 determines that the exclusive queue 54 is in a waiting state and schedules the status 54h as abnormal. When the exclusive queue 54 is in a waiting state, the exclusive information 50 is memory-locked by the close processing unit 225 (described below).

When no other exclusive queue 54 in the occupancy mode (EX) exists, the write processing unit 223 updates the corresponding statistical information entry 41 of the statistical information 40.

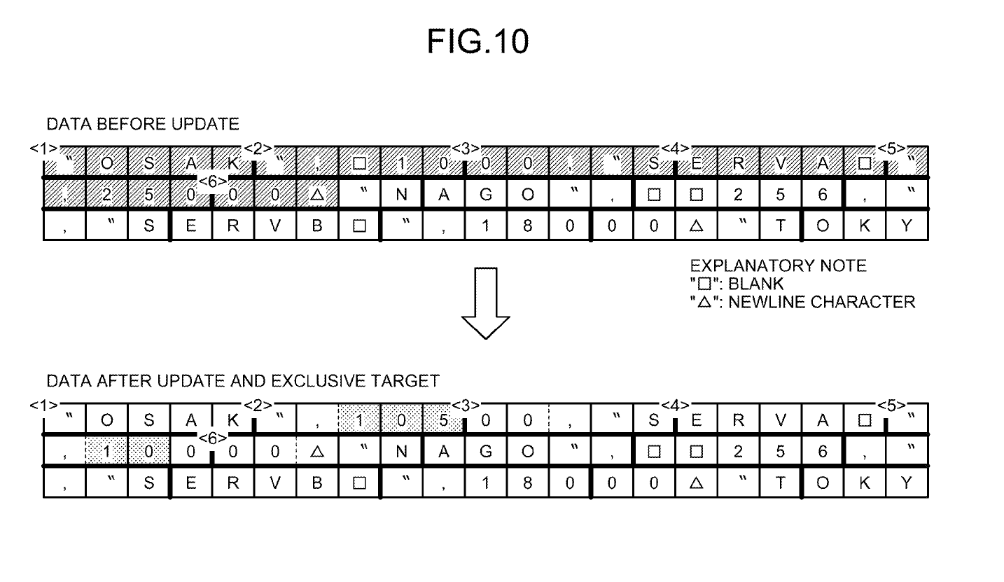

Here, an exclusive target block will be described with reference to FIG. 10. FIG. 10 is a diagram explaining the exclusive target block. In FIG. 10, the block of the processing target file 30 is 5 bytes. Further, the write size specified by the application 21 is 28 bytes.

As illustrated in the upper figure in FIG. 10, data of a write target area before update is represented. Blocks 1 to 6 are write targets.

As illustrated in the lower figure in FIG. 10, data after update when the data requested to be written has been actually updated is represented. The write processing unit 223 reads data of all blocks to be write targets and compares the read data with the data requested to be written to thereby decide the presence or absence of change for each of the blocks. In this example, the block 2 and the block 5 have a change. In the block 2, data before the update is “ ”, 10″, and, on the other hand, data after the update is “ ”, 105″. Therefore, it is decided that there is a change in the block 2. In the block 5, data before the update is “ ”, 250″, and, on the other hand, data after the update is “ ”, 100″. Therefore, it is decided that there is a change in the block 5. That is, the blocks 2, 5 are determined to be exclusive target blocks.

Referring back to FIG. 1, the seek processing unit 224 changes the access position to the specified position and changes offset of the processing target file 30.

The close processing unit 225 decides whether data contention with another application 21 occurs using the exclusive information 50 as close processing for the processing target file 30. The close processing unit 225 memory-locks the exclusive information 50 so as to prevent processing of another application 21 from operating at the same time during the close processing. This is because of that, if processing of another application 21 operates at the same time during the close processing, exclusive information 50 is added along with the operation, that is, the close processing unit 225 is caused to wait the decision of data contention using the exclusive information 50 until the addition of the exclusive information 50 stops.

For example, the close processing unit 225 searches the exclusive queue 54 in the direction connected from the transaction entry 521 in the own application 21. Then, when there is an exclusive queue 54 in which the exclusive mode is the occupancy mode (EX), the close processing unit 225 further searches an exclusive queue 54 of another application 21 in which the exclusive mode is the share mode (SH) before the exclusive queue 54 in the occupancy mode. The search follows the direction connected from the block information 512 that corresponds to the block managed by the exclusive queue 54. Then, when there is an exclusive queue 54 of another application 21 in which the exclusive mode is the share mode (SH) before the exclusive queue 54 in the occupancy mode, the close processing unit 225 waits the finish of the transaction of the other application 21. Then, when the status 54h is scheduled as abnormal by the write processing unit 223 from the other application 21, the close processing unit 225 determines the occurrence of data contention and returns as an error. On the other hand, when there is an exclusive queue 54 in which the exclusive mode is the share mode (SH), the close processing unit 225 further searches an exclusive queue 54 of another application 21 in which the exclusive mode is the occupancy mode (EX) after the exclusive queue 54 in the share mode. Then, when there is the exclusive queue 54 of the other application 21 in which the exclusive mode is the occupancy mode (EX) after the exclusive queue 54 in the share mode, the close processing unit 225 schedules the status 54h of the exclusive queue 54 of the other application 21 as normal.

Further, the close processing unit 225 performs update processing on the processing target file 30 as close processing for the processing target file 30 after the search of the exclusive queue 54. For example, the close processing unit 225 searches an exclusive queue 54 in which the exclusive mode is the occupancy mode (EX) in the direction connected from the transaction entry 521 in the own application 21. Then, the close processing unit 225 writes data of the updated log 60 indicated by the updated log area 54i into the processing target file 30 for the exclusive queue 54 in which the exclusive mode is the occupancy mode (EX).

Further, the close processing unit 225 closes the processing target file 30 as the close processing for the processing target file 30.

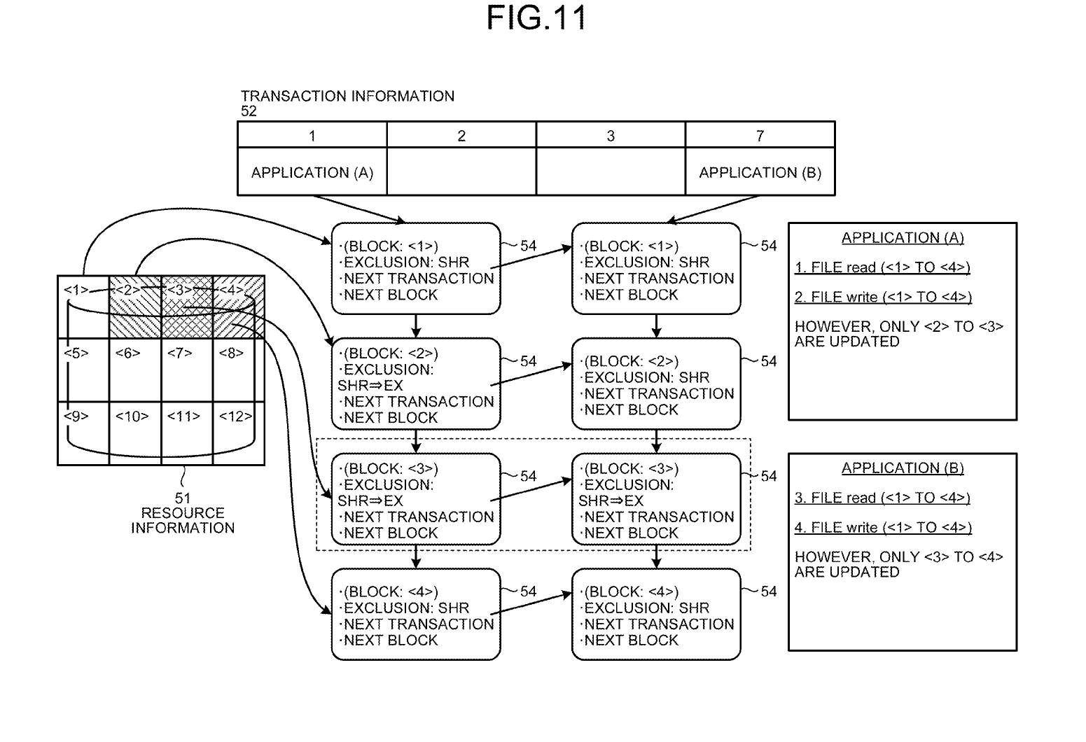

Next, exclusive control of the access control processing according to the embodiment will be described with reference to FIG. 11. FIG. 11 is a diagram explaining the exclusive control of the access control processing according to the embodiment. In FIG. 11, the application A and the application B execute batch processing using the processing target file 30 in parallel. In the resource information 51, the block information 512 that corresponds to the processing target file 30 is stored for each of the blocks 1 to 12. In the transaction information 52, the transaction entry 521 that corresponds to the application is stored for each of the applications A, B. As illustrated in FIG. 11, in the application A, processing of reading data of the read size regarding the blocks 1 to 4 and writing data requested to be written regarding the blocks 1 to 4 is performed on the processing target file 30. In this case, the blocks 2 and 3 are actually updated. Further, in the application B, processing of reading data of the read size regarding the blocks 1 to 4 and writing data requested to be written regarding the blocks 1 to 4 is performed on the processing target file 30. In this case, the blocks 3 and 4 are actually updated. Accordingly, contention of the block 3 occurs between the application A and the application B.

Under such conditions, for example, when the write processing unit 223 is called from the application A, the write processing unit 223 determines the block 3 as an update target, that is, an exclusive target. Then, the write processing unit 223 follows the exclusive queues 54 from the block information 512 that corresponds to the exclusive target block 3 in the resource information 51 to thereby decide whether an exclusive queue 54 in the occupancy mode (EX) exists in the other exclusive queues 54. In this example, the write processing unit 223 decides that an exclusive queue 54 in the occupancy mode (EX) exists in the application B. Then, because the block 3 is excluded in the occupancy mode (EX), the write processing unit 223 determines the occurrence of contention and thereby determines an exclusive error. As a result, even when the applications A and B operate in parallel, the applications A and B can perform write processing on the same access target, that is, the same processing target file 30 without affecting each other.

Procedure of Open Processing

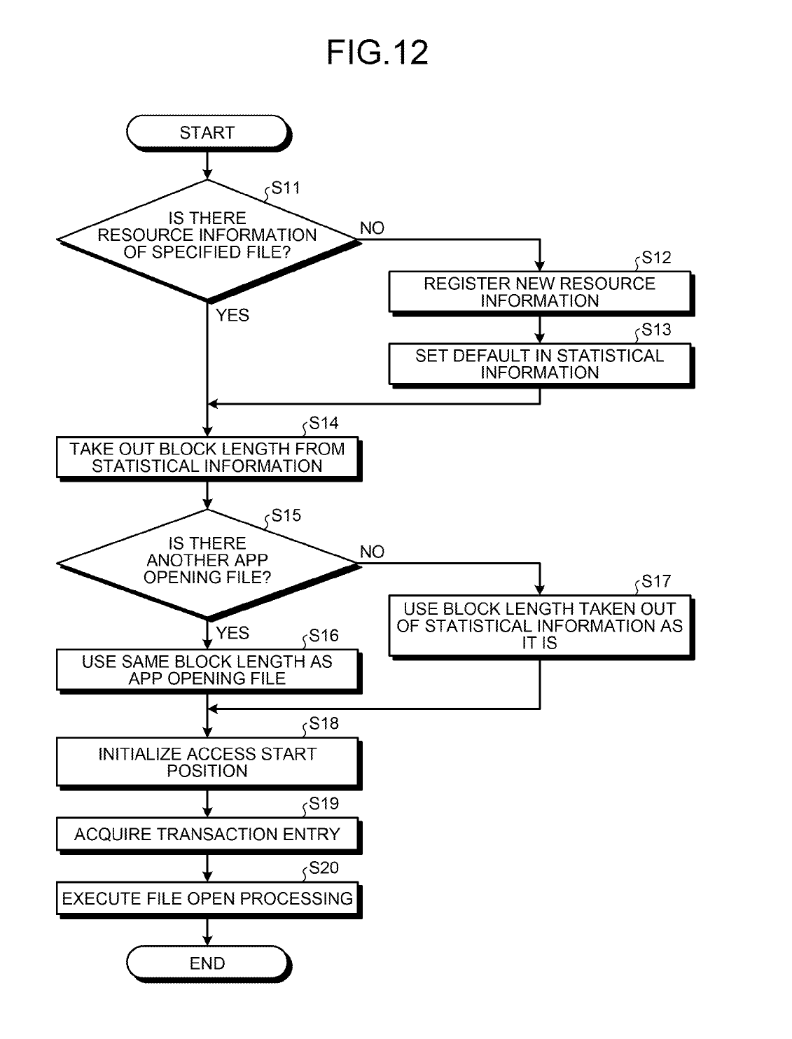

Next, the procedure of open processing will be described with reference to FIG. 12. FIG. 12 is a flowchart illustrating the procedure of the open processing according to the present embodiment. In FIG. 12, it is assumed that a file name of a processing target file 30 to be opened is specified by the application 21.

The open processing unit 221 decides whether there is resource information 51 of a file specified by the application 21 (step S11). For example, the open processing unit 221 decides whether there is a resource information entry 511 that corresponds to a file name of a file specified by the application 21 with reference to the resource information 51.

When deciding that there is the resource information 51 of the file (Yes in step S11), the open processing unit 221 shifts the processing to step S14. On the other hand, when deciding that there is no resource information 51 of the file (No in step S11), the open processing unit 221 registers a new resource information entry 511 in the resource information 51 (step S12). Then, the open processing unit 221 registers a new statistical information entry 41 that corresponds to the application 21 and the specified file and sets default in the statistical information 40 (step S13). Then, the open processing unit 221 shifts the processing to step S14.

In step S14, the open processing unit 221 takes out a block length from the statistical information 40 (step S14). For example, the open processing unit 221 takes out a block length that corresponds to the application 21 and the specified file from the statistical information 40 depending on the tuning class 41h. As an example, the open processing unit 221 takes out a value that is set to the average value 41g as the block length when the tuning class 41h is “AVE”.

Then, the open processing unit 221 decides whether another application 21 that is opening the specified file exists (step S15). For example, the open processing unit 221 decides whether a value of the open number 511b is larger than zero with reference to the resource information entry 511 that corresponds to the specified file.

When deciding that another application 21 that is opening the specified file exists (Yes in step S15), the open processing unit 221 allows the same block length as the block length of the application 21 that is opening the specified file to be used (step S16). That is, the open processing unit 221 takes out a value of the block length 511c as the block length with reference to the resource information entry 511 that corresponds to the specified file. Then, the open processing unit 221 shifts the processing to step S18.

On the other hand, when deciding that no other application 21 that is opening the specified file exists (No in step S15), the open processing unit 221 allows the block length that is taken out of the statistical information 40 to be used as it is (step S17). Then, the open processing unit 221 shifts the processing to step S18.

Then, the open processing unit 221 initializes an access start position at which the access is started (step S18). Then, the open processing unit 221 acquires a transaction entry 521 that corresponds to the application 21 from the transaction information 52 (step S19). At this point, the open processing unit 221 acquires access information 53 that corresponds to the file accessed from the application 21 and sets the access start position at the access position 53b in the acquired access information 53. Then, the open processing unit 221 executes open processing for the specified file (step S20).

Procedure of Read Processing

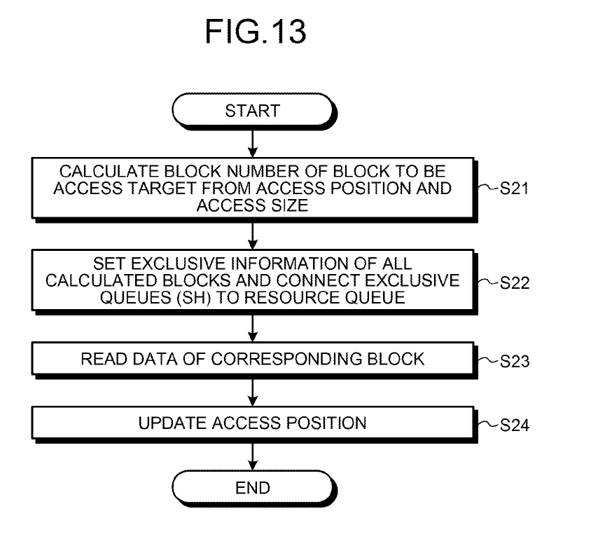

Next, the procedure of read processing will be described with reference to FIG. 13. FIG. 13 is a flowchart illustrating the procedure of the read processing according to the embodiment. In FIG. 13, it is assumed that a file name of the processing target file 30, an access position, and an access size are specified by the application 21.

The read processing unit 222 calculates block numbers of blocks to be access targets on the basis of the access position and the access size specified by the application 21 (step S21).

Then, the read processing unit 222 sets exclusive information 50 of all blocks corresponding to all of the calculated block numbers (step S22). That is, the read processing unit 222 connects the exclusive queues 54 in the share mode (SH) to a queue relating to the resource. For example, the read processing unit 222 connects the exclusive queues 54 in the share mode (SH) corresponding to all of the calculated blocks in the direction connected from the transaction entry 521 that corresponds to the application 21. As an example, the read processing unit 222 sets the head exclusive queue address 521c and the final exclusive queue address 521d of the transaction entry 521 that corresponds to the application 21 and also sets the previous block address 54e and the next block address 54f of the exclusive queue 54. Further, the read processing unit 222 connects the exclusive queues 54 in the share mode (SH) corresponding to all of the calculated blocks in the direction connected from the block information 512 in the resource information 51 for each of the blocks. As an example, the read processing unit 222 sets the head exclusive queue address 512b and the final exclusive queue address 512c that correspond to each of the blocks and also sets the previous transaction address 54c and the next transaction address 54d of the exclusive queue 54.

Then, the read processing unit 222 reads data of the blocks corresponding to the calculated block numbers from the specified file (step S23). Then, the read processing unit 222 updates the access position and the sets the access position to the access position 53b of the corresponding access information 53 (step S24).

Procedure of Write Processing

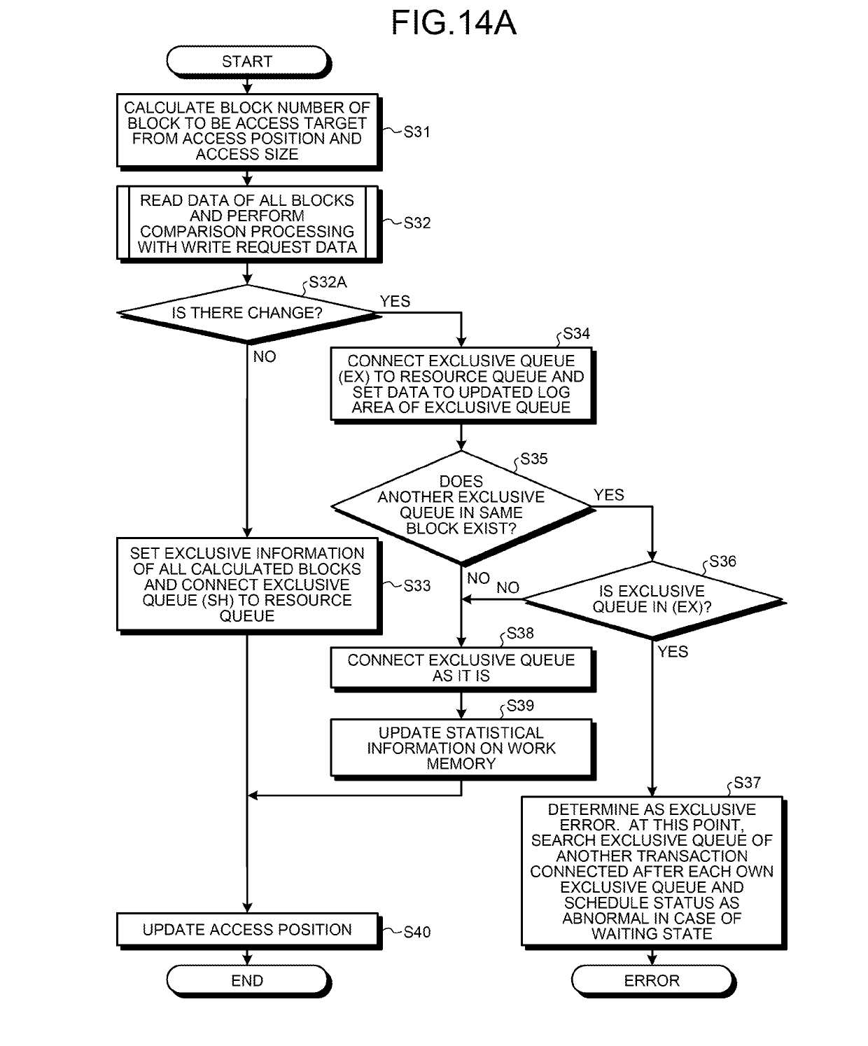

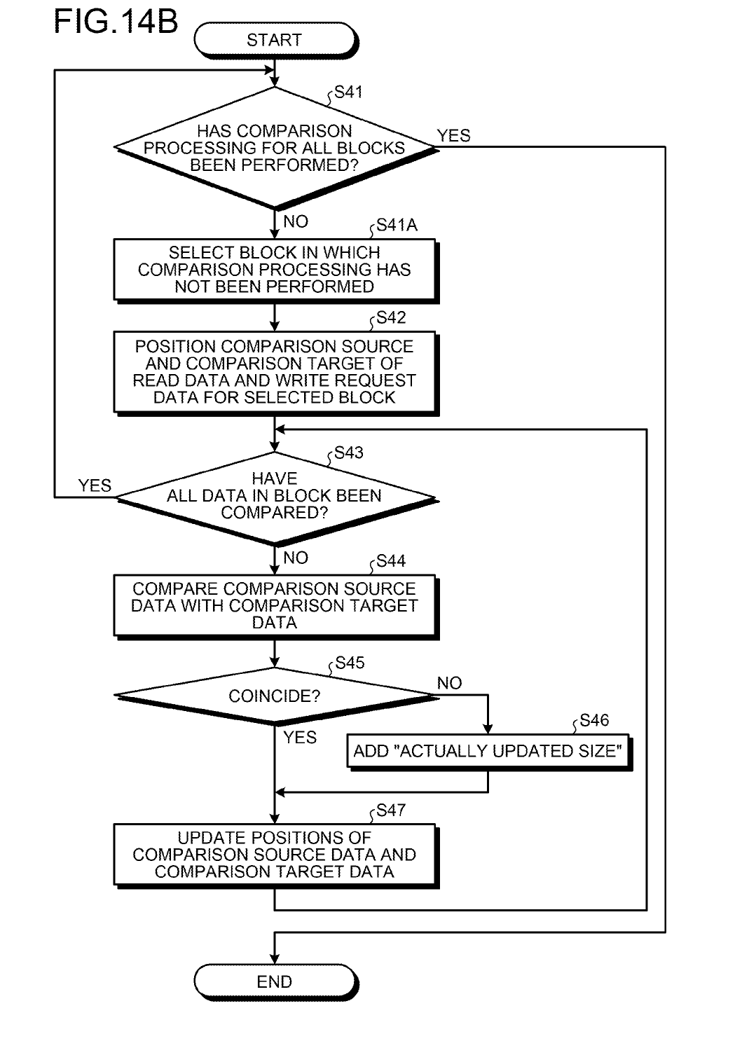

Next, the procedure of write processing will be described with reference to FIGS. 14A and 14B. FIGS. 14A and 14B are flowcharts each illustrating the procedure of the write processing according to the embodiment. In FIG. 14A, it is assumed that a file name of the processing target file 30, an access position, an access size, and write request data are specified by the application 21.

The write processing unit 223 calculates block numbers of blocks to be access targets on the basis of the access position and the access size specified by the application 21 (step S31). Then, the write processing unit 223 reads data of all blocks that correspond to all of the calculated block numbers and executes comparison processing with the write request data (step S32). The comparison processing will be described with reference to FIG. 14B.

Then, the write processing unit 223 decides whether there is a change on the basis of the result of the comparison processing (step S32A). When deciding that there is no change (No in step S32A), the write processing unit 223 sets the exclusive information 50 of all of the blocks corresponding to all of the calculated block numbers (step S33). That is, the write processing unit 223 connects the exclusive queues 54 in the share mode (SH) to the queue relating to the resource. For example, the write processing unit 223 connects the exclusive queues 54 in the share mode (SH) corresponding to all of the calculated blocks in the direction connected from the transaction entry 521 that corresponds to the application 21. Further, the write processing unit 223 connects the exclusive queues 54 in the share mode (SH) corresponding to all of the calculated blocks in the direction connected from the block information 512 in the resource information 51 for each of the blocks. Then, the write processing unit 223 shifts the processing to step S40.

On the other hand, when deciding that there is a change (Yes in step S32A), the write processing unit 223 connects the exclusive queue 54 in the occupancy mode (EX) to the queue relating to the resource. For example, the write processing unit 223 connects the exclusive queue 54 in the occupancy mode (EX) corresponding to the block having a change in the direction connected from the block information 512 in the resource information 51 for the block having a change. Then, the write processing unit 223 writes the updated data corresponding to the block having a change into the updated log 60 (step S34). At this point, the write processing unit 223 sets the head address of the updated data written into the updated log 60 to the updated log area 54i of the exclusive queue 54.

Then, the write processing unit 223 decides whether another exclusive queue 54 that corresponds to the same block as the block having a change exists (step S35). For example, the write processing unit 223 follows the exclusive queues 54 from the block information 512 that corresponds to the corresponding block in the resource information 51 to thereby decide whether another exclusive queue 54 exists.

When deciding that no other exclusive queue 54 that corresponds to the same block as the block having a change (No in steps S35), the write processing unit 223 shifts the processing to step S38. On the other hand, when deciding that another exclusive queue 54 that corresponds to the same block as the block having a change exists (Yes in step S35), the write processing unit 223 decides whether the exclusive queue 54 is in the occupancy mode (EX) (step S36). When deciding that the exclusive queue 54 is not in the occupancy mode (EX) (No in step S36), the write processing unit 223 shifts the processing to step S38.

On the other hand, when deciding that the exclusive queue 54 is in the occupancy mode (EX) (Yes in step S36), the write processing unit 223 determines that data contention occurs in the same block and thereby determines an exclusive error. At this point, the write processing unit 223 searches an exclusive queue 54 of another transaction that is connected after the own exclusive queue 54. When other than NULL is set to the waiting state 54g, data contention occurs in the same block. Therefore, the write processing unit 223 then sets and schedules the status 54h as “abnormal” (step S37). Then, the write processing unit 223 finishes the write processing as an error.

In step S38, the write processing unit 223 connects the exclusive queue 54 in the occupancy mode (EX) corresponding to the block having a change as it is in the direction connected from the transaction entry 521 that corresponds to the application 21 (step S38). Then, the write processing unit 223 updates the statistical information on a work memory of the RAM 4 (step S39). For example, the write processing unit 223 temporarily stores, as the statistical information, the total amount of “the actually updated size” of the block having a change, the number of times of update performed in the past, and the maximum size and the minimum size in the update in the work memory regarding the access to the specified file. Then, the write processing unit 223 shifts the processing to step S40.

In step S40, the write processing unit 223 updates the access position and sets the updated access position to the access position 53b of the corresponding access information 53 (step S40).

Next, the comparison processing will be described. The write processing unit 223 decides whether the comparison processing for all of the blocks has been performed (step S41). On the other hand, when deciding that the comparison processing for all of the blocks has not been performed (No in step S41), the write processing unit 223 selects a block in which the compassion processing has not been performed (step S41A).

Then, the write processing unit 223 positions a comparison source and a comparison target of read data and write request data for the selected block (step S42). Then, the write processing unit 223 decides whether all data in the selected block has been compared (step S43). When deciding that all of the data in the selected block has been compared (Yes in step S43), the write processing unit 223 shifts the processing to step S41 in order to select the next block.

On the other hand, when deciding that all of the data in the selected block has not been compared (No in step S43), the write processing unit 223 compares the comparison source data with the comparison target data (step S44). The write processing unit 223 decides whether the comparison source data and the comparison target data coincide with each other (step S45).

When deciding that the comparison source data and the comparison target data coincide with each other (Yes in step S45), the write processing unit 223 shifts the processing to step S47. On the other hand, when deciding that the comparison source data and the comparison target data do not coincide with each other (No in step S45), the write processing unit 223 adds “the actually updated size” to the uncoincident data (step S46). Then, the write processing unit 223 shifts the processing to step S47.

In step S47, the write processing unit 223 updates the positions of the comparison source data and the comparison target data (step S47). Then, the write processing unit 223 transitions the processing to step S43 in order to perform the data comparison using the updated positions.

Then, when deciding that comparison processing for all of the blocks has been performed in step S41 (Yes in step S41), the write processing unit 223 finishes the decision processing.

Procedure of Seek Processing

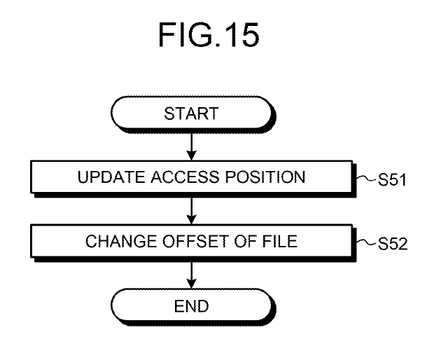

Next, the procedure of seek processing will be described with reference to FIG. 15. FIG. 15 is a flowchart illustrating the procedure of the seek processing according to the embodiment. In FIG. 15, it is assumed that the access position of the processing target file 30 is specified by the application 21.

The seek processing unit 224 updates the specified access position and sets the updated access position to the access position 53b of the corresponding access information 53 (step S51). Then, the seek processing unit 224 changes offset of the file depending on the specified access position (step S52).

Procedure of Close Processing

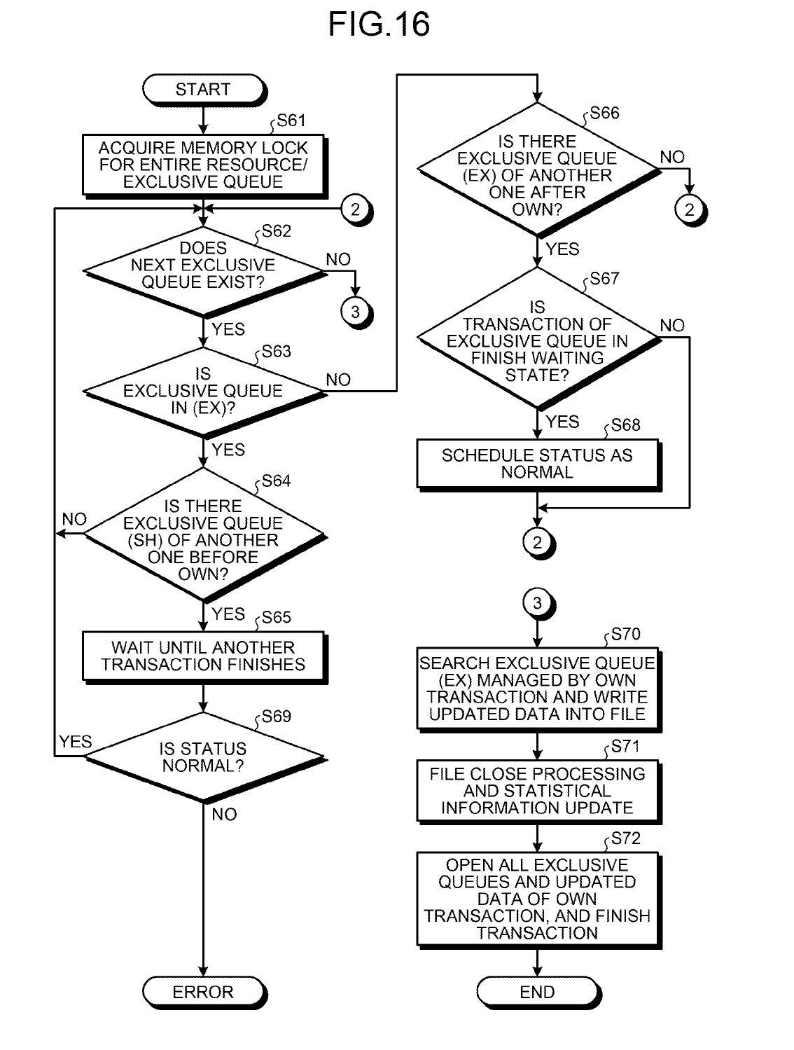

Next, the procedure of close processing will be described with reference to FIG. 16. FIG. 16 is a flowchart illustrating the procedure of the close processing according to the embodiment. In FIG. 16, it is assumed that a close processing order for the processing target file 30 is issued from the application 21.

First, the close processing unit 225 acquires memory lock for the entire resource information 51 and the entire exclusive queues 54 (step S61). The acquisition of the memory lock is performed in order to prevent processing of another application 21 from operating at the same time until the close processing from the application 21 in which the close processing order has been issued finishes.

Then, the close processing unit 225 decides whether the next exclusive queue 54 exists (step S62). For example, the close processing unit 225 decides whether there is an exclusive queue 54 that is connected next in order from the head exclusive queue address 521c set in the transaction entry 521 in the own application 21. When deciding that the next exclusive queue 54 exists (Yes in step S62), the close processing unit 225 selects the next exclusive queue 54 and decides whether the selected exclusive queue 54 is in the occupancy mode (EX) (step S63).

When deciding that the selected exclusive queue 54 is in the occupancy mode (EX) (Yes in step S63), the close processing unit 225 decides whether an exclusive queue 54 in the share mode (SH) of another application 21 exists before the own exclusive queue 54 (step S64). For example, the close processing unit 225 follows the exclusive queues 54 located in the direction connected from the block information 512 that corresponds to the block managed by the own exclusive queue 54. Then, the close processing unit 225 decides whether there is an exclusive queue 54 in the share mode (SH) of another application 21 before the own exclusive queue 54.

When deciding that there is no exclusive queue 54 in the share mode (SH) of another application 21 before the own exclusive queue 54 (No in step S64), the close processing unit 225 shifts the processing to step S62 in order to decide the next exclusive queue 54. On the other hand, when deciding that there is an exclusive queue 54 in the share mode (SH) of another application 21 before the own exclusive queue 54 (Yes in step S64), the close processing unit 225 waits until the transaction of the other application 21 finishes (step S65). This is because of that it is not clear whether the other application 21 performs write processing to the same block as the block managed by the own exclusive queue 54 until the transaction of the other application 21 finishes.

After the transaction of the other application 21 finishes, the close processing unit 225 decides whether the status 54h of the own exclusive queue 54 is normal (step S69). That is, the close processing unit 225 decides whether the status 54h of the own exclusive queue 54 is not scheduled as abnormal by the write processing unit 223 of the other application 21. When deciding that the status 54h of the own exclusive queue 54 is normal (Yes in step S69), the close processing unit 225 shifts the processing to step S62 in order to decide the next exclusive queue 54.

On the other hand, when deciding that the status 54h of the own exclusive queue 54 is not normal (No in step S69), the close processing unit 225 determines that data contention occurs and finishes the processing as an error.

In step S63, when deciding that the selected exclusive queue 54 is not in the occupancy mode (EX) (No in step S63), the close processing unit 225 decides whether there is an exclusive queue 54 in the occupancy mode (EX) of another application 21 after the own exclusive queue 54 (step S66). For example, the close processing unit 225 follows the exclusive queues 54 located in the direction connected from the block information 512 that corresponds to the block managed by the own exclusive queue 54. Then, the close processing unit 225 decides whether there is an exclusive queue 54 in the occupancy mode (EX) of another application 21 after the own exclusive queue 54.

When deciding that there is no exclusive queue 54 in the occupancy mode (EX) of another application 21 after the own exclusive queue 54 (No in step S66), the close processing unit 225 shifts the processing to step S62 in order to decides the next exclusive queue 54. On the other hand, when deciding that there is an exclusive queue 54 in the occupancy mode (EX) of another application 21 after the own exclusive queue 54 (Yes in step S66), the close processing unit 225 decides whether the transaction of the other exclusive queue 54 is in a finish waiting state (step S67). For example, the close processing unit 225 decides whether the waiting state 54g of the other exclusive queue 54 is other than NULL.

When deciding that the transaction of the other exclusive queue 54 is in the finish waiting state (Yes in step S67), the close processing unit 225 sets and schedules the status 54h as “normal” (step S68) because it is determined that no data contention occurs in the same block. Then, the close processing unit 225 shifts the processing to step S62 in order to decide the next exclusive queue 54.

On the other hand, when deciding that the transaction of the other exclusive queue 54 is not in the finish waiting state (No in step S67), the close processing unit 225 shifts the processing to step S62 in order to decide the next exclusive queue 54.

When deciding that no next exclusive queue 54 exists in step S62 (No in step S62), the close processing unit 225 searches an exclusive queue 54 in the occupancy mode (EX) managed by the own transaction. Then, the close processing unit 225 writes the updated data into the file (step S70). For example, the close processing unit 225 searches the exclusive queue 54 in the occupancy mode (EX) in the direction connected from the transaction entry 521 in the own application 21. Then, the close processing unit 225 writes data of the updated log 60 indicated by the updated log area 54i of the exclusive queue 54 in the occupancy mode (EX) into the file.

Then, the close processing unit 225 executes the close processing for the file. Then, the close processing unit 225 updates the statistical information on the work memory to the corresponding statistical information entry 41 in the statistical information 40 (step S71). Then, the close processing unit 225 opens all exclusive queues 54 and the updated data of the own transaction and finishes the transaction (step S72).

### Specific Example of Access Control Processing

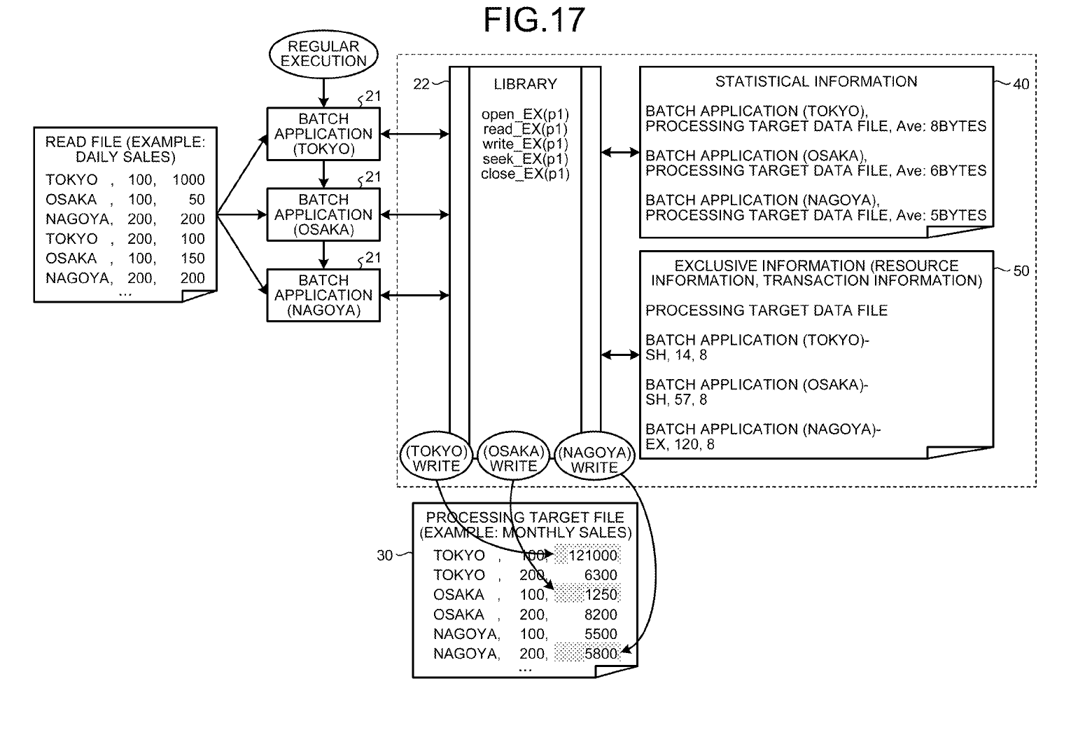

Next, a specific example of the access control processing according to the embodiment will be described with reference to FIG. 17. FIG. 17 is a diagram illustrating a specific example of the access control processing according to the embodiment. As illustrated in FIG. 17, batch applications 21 are executed at regular intervals. The batch applications 21 execute transaction for calculating monthly sales from daily sales and writing the calculated monthly sales into the processing target file 30 for the monthly sales for TOKYO, OSAKA, and NAGOYA.

Each of the batch applications 21 calls a module of open_EX( ) a module of read_EX( ) a module of write_EX( ) a module of seek_EX( ) and a module of close_EX( ) of the library 22 depending on programming. The open_EX( ) corresponds to the open processing unit 221. The read_EX( ) corresponds to the read processing unit 222. The write_EX( ) corresponds to the write processing unit 223. The seek_EX( ) corresponds to the seek processing unit 224. The close_EX( ) corresponds to the close processing unit 225.

Each of the modules perform processing using the statistical information 40 and the exclusive information 50. Specifically, in order to read daily sales regarding TOKYO, the batch application 21 regarding TOKYO calls the read_EX( ) to thereby read data corresponding to TOKYO from the read file. Then, in order to calculate monthly sales using the read data and write the monthly sales regarding TOKYO, the batch application 21 calls the write_EX( ) to thereby write the data corresponding to TOKYO into the processing target file 30. Then, the batch application 21 calls the close_EX( ) to thereby close the read file and the processing target file 30. In the same manner as in the case of TOKYO, the batch applications 21 regarding OSAKA and NAGOYA also respectively write data corresponding to OSAKA and NAGOYA into the processing target file 30.

Even when the applications 21 of TOKYO, OSAKA, and NAGOYA are executed in parallel, the access control processing can correctly write the calculated result into a part corresponding to each of the place names when contention of blocks to be written into the processing target file 30 does not occur. Even if contention of blocks to be written into the processing target file 30 occurs, the access control processing can determines an error. Therefore, in the access control processing, even when the batch applications 21 of TOKYO, OSAKA, and NAGOYA are executed in parallel, the batch applications 21 can access the same processing target file 30 without affecting each other.

### Specific Example of Controller

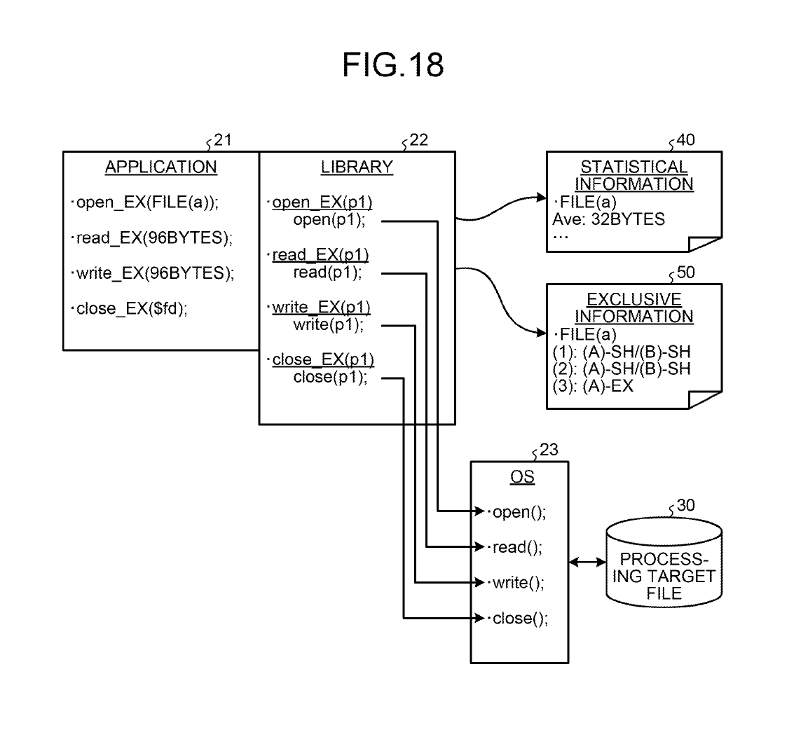

Next, a specific configuration example of the controller 1 according to the embodiment will be described with reference to FIG. 18. FIG. 18 is a diagram illustrating a specific configuration example of the controller according to the embodiment. As illustrated in FIG. 18, the application 21 is a program that is programmed by each of the modules provided in the library 22.

Each of the modules is provided in the library 22. In this example, the module of open_EX( ) the module of read_EX( ) the module of write_EX( ) and the module of close_EX( ) are provided. The open_EX( ) corresponds to the open processing unit 221. The read_EX( ) corresponds to the read processing unit 222. The write_EX( ) corresponds to the write processing unit 223. The close_EX( ) corresponds to the close processing unit 225.

Each of the modules accesses the statistical information 40 and the exclusive information 50. In addition, each of the modules calls a module provided by the OS 23. Specifically, the module of open_EX( ) calls open( ) provided by the OS 23. The module of read_EX( ) calls read ( ) provided by the OS 23. The module of write_EX( ) calls write( ) provided by the OS 23. The module of close_EX( ) calls close( ) provided by the OS 23. Then, the processing target file 30 is accessed by each of the modules provided by the OS 23.

The controller 1 having such a configuration executes the access control processing.

### Effect of Embodiment

According to the above embodiment, the controller 1 accumulates, for each of the applications 21 executed by batch processing, the exclusive information 50 of a block as an area corresponding to the access position and the size of the access area when the application 21 accesses the storage area of the processing target file 30. Then, when any of the applications 21 accesses the storage area of the processing target file 30, the controller 1 executes exclusive control for the area specified by the exclusive information 50 of the block in the storage area on the basis of the accumulated exclusive information 50 of the block. With such a configuration, even when a plurality of applications 21 are processed in parallel, waiting in any of the applications 21 in the unit of processing target file 30 is not caused, and the controller 1 can therefore efficiently achieve the batch processing. That is, in the controller 1, a plurality of applications can access the processing target file 30 without affecting each other. Further, the controller 1 can achieve the exclusive control in the unit of item (block) even when a user does not previously shift the processing target file 30 to DB (database).

According to the above embodiment, the controller 1 logically divides the storage area of the processing target file 30 into blocks each having a predetermined length and accumulates the exclusive information 50 of the blocks. Then, the controller 1 executes the exclusive control for a block that corresponds to the accessed area. With such a configuration, even when a plurality of applications 21 are processed in parallel, waiting in the unit of file is not caused by performing the exclusive control in the unit of block. As a result, the controller 1 can efficiently achieve the batch processing.

According to the above embodiment, the controller 1 accumulates, for each of the applications 21, the exclusive information 50 of a block that corresponds to the read area and a block that corresponds to an area having a different value from data to be written in the write area. Then, the controller 1 decides whether there is exclusive information 50 of the same block as the block corresponding to the area having a different value from the data to be written in the area into which the data is actually written with reference to the accumulated exclusive information 50 of the block that corresponds to another application 21. Then, when there is the exclusive information 50 of the same block and the exclusive information 50 of the referred block is the exclusive information 50 of the block relating to the write, the controller 1 executes the exclusive control for the corresponding block. With such a configuration, the controller 1 can localize the range of the exclusive control by executing the exclusive control for the block that corresponds to the area having a different value from the data to be written.

Further, according to the above embodiment, the controller 1 sets the length of a block to a length using the size of data whose value has been actually updated, divides the storage area of the processing target file 30 into blocks each having the above length, and accumulates information of the accessed block. With such a configuration, the controller 1 can optimize the block length by changing the block length in accordance with the size of data whose value has been actually updated.

Program and the Like

In the embodiment, a single processing target file 30 is stored in the HDD 3. However, a plurality of processing target files 30 may also be stored in the HDD 3. In the HDD 3, a file accessed by the applications 21 may be stored.

The controller 1 can be achieved by mounting the above functions such as the control unit 2, the HDD 3, and the RAM 4 on an information processing device such as a known personal computer and a known work station.

Further, the elements of the illustrated device do not always need to be physically configured as illustrated. That is, a specific mode of disintegration/integration of the device is not limited to the illustrated one, and the entire or a part thereof may be functionally or physically disintegrated or integrated in any unit depending on various loads or the condition of use. For example, the library 22 may be integrated with the OS 23. On the other hand, the open processing unit 221 may be disintegrated into a processing unit for determining the block length of the processing target file 30 and a processing unit for opening the processing target file 30. Further, the HDD 3 may be connected via network as the external device of the controller 1.

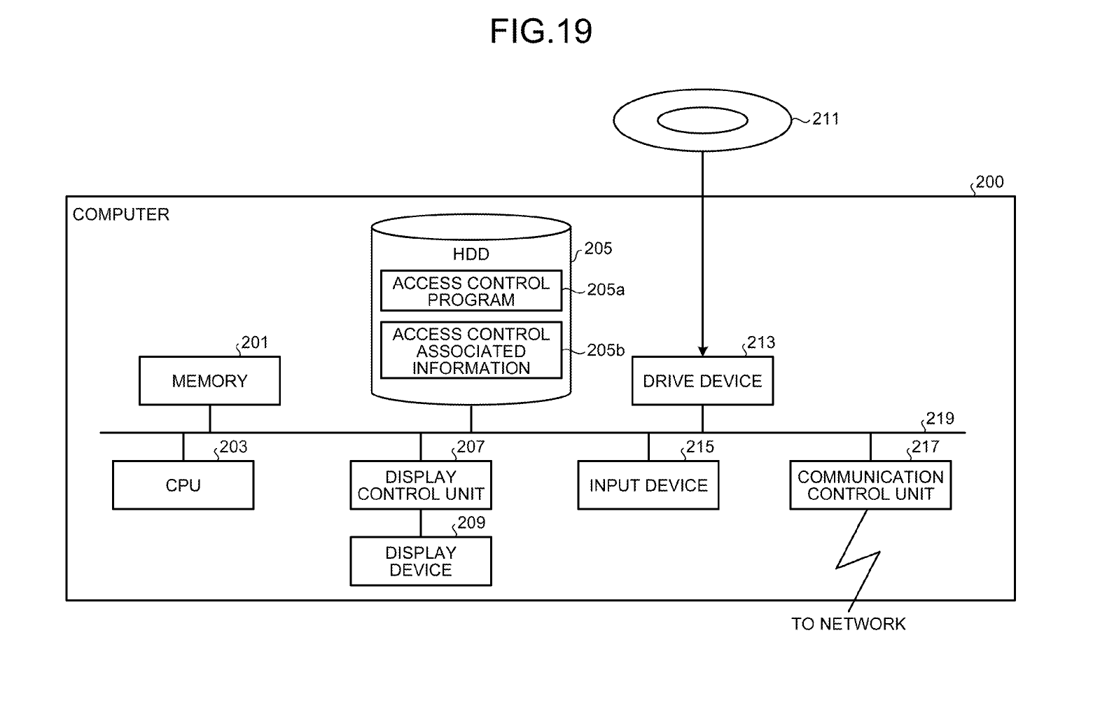

Further, various kinds of processing described in the above embodiment can be achieved by executing previously prepared programs by a computer such as a personal computer or a work station. Hereinbelow, an example of a computer that executes an access control program that achieves the same function as the controller 1 illustrated in FIG. 1 will be described. FIG. 19 is a diagram illustrating an example of the computer that executes the access control program.

As illustrated in FIG. 19, a computer 200 includes a CPU 203 which executes various kinds of arithmetic processing, an input device 215 which receives the input of data from a user, and a display control unit 207 which controls a display device 209. Further, the computer 200 includes a drive device 213 which reads a program and the like from a storage medium and a communication control unit 217 which performs transmission/reception of data with another computer via network. Further, the computer 200 includes a memory 201 which temporarily stores various pieces of information and an HDD 205. The memory 201, the CPU 203, the HDD 205, and the display control unit 207, the drive device 213, the input device 215, the communication control unit 217 are connected to each other through a bus 219.

The drive device 213 is a device for, for example, a removable disk 211. The HDD 205 stores an access control program 205a and access control associated information 205b.

The CPU 203 reads the access control program 205a and develops the read access control program 205a in the memory 201 to execute the developed read access control program 205a as a process. The process corresponds to each of the functional units of the controller 1. The CPU 203 develops the statistical information 40 and the exclusive information 50 of the controller 1 during performing the process. The access control associated information 205b corresponds to the processing target file 30. Further, for example, the removable disk 211 stores each piece of information such as the access control program 205a.

The access control program 205a need not be stored in the HDD 205 from the beginning. For example, the program is stored, for example, in “portable physical medium” that is inserted into the computer 200 such as a flexible disk (FD), a CD-ROM, a DVD disk, a magneto optical disk, and an IC card. Then, the computer 200 may read the access control program 205a from the portable physical medium and execute the read access control program 205a.

According to one aspect, it is possible to efficiently execute parallel processing in a plurality of applications in batch processing.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium storing therein an access control program that causes a computer to execute a process comprising:
accumulating, for each of a plurality of applications executed by batch processing, an area information indicating information of an access position and a size of an access area when the application accesses a storage area of a storage unit; and
executing, when any of the applications accesses the storage area, exclusive control for an area that is specified by the area information and that corresponds to the any of the applications on the basis of the area information accumulated at the accumulating.

2. The non-transitory computer-readable recording medium according to claim 1, wherein
the accumulating logically divides the storage area into blocks each having a predetermined length and accumulates information of a block corresponding to an area of the area information, and
the executing executes exclusive control for a block corresponding to the accessed area.

3. The non-transitory computer-readable recording medium according to claim 1, wherein
the accumulating accumulates, for each application, information of a block corresponding to a read area and information of a block corresponding to an area having a different value from data to be written in a write area, and
the executing refers to information of blocks corresponding to a plurality of applications, the information being accumulated at the accumulating, and, when information of the same block as a block corresponding to an area having a different value from data to be written in an area in which the data is actually written is accumulated and information of a referred block is information of a block relating to write, the executing executes exclusive control for the block.

4. The non-transitory computer-readable recording medium according to claim 2, wherein the accumulating sets the length of the block to a length using the size of data whose value is actually updated, divides the storage area into blocks having the length, and accumulates information of a block corresponding to an area of the area information.

5. A controller comprising:
a processor; and
a memory, wherein the processor executes:
accumulating, for each of a plurality of applications executed by batch processing, an area information indicating information of an access position and a size of an access area when the application accesses a storage area of a storage unit; and
executing, when any of the applications accesses the storage area, exclusive control for an area that is specified by the are information and that corresponds to the any of the applications on the basis of the area information accumulated at the accumulating.

6. An access control method executed by a computer, the method comprising:
accumulating, for each of a plurality of applications executed by batch processing, an area information indicating information of an access position and a size of an access area when the application accesses a storage area of a storage unit using a processor; and
executing, when any of the applications accesses the storage area, exclusive control for an area that is specified by the area information and that corresponds to the any of the applications on the basis of the area information accumulated at the accumulating using the processor.
